(19) United States
(12) Patent Application Publication
(10) Pub. No.: US 2013/0293775 A1
(43) Pub. Date: Nov. 7, 2013

(54) RECORDER FOR DIGITAL CAPTION BROADCAST

(71) Applicant: Kunihiro Shibata, Shinjuku-ku (JP)

(72) Inventor: Kunihiro Shibata, Shinjuku-ku (JP)

(73) Assignee: Speed WP Inc., Shinjuku (JP)

(21) Appl. No.: 13/512,087

(22) PCT Filed: Jun. 28, 2011
(86) PCT No.: PCT/JP11/03671

§ 371 Date: May 25, 2012

(30) Foreign Application Priority Data
Jan. 7, 2011 (JP) 2011-001766

(51) Int. Cl. H04N 7/035

(52) U.S. Cl. CPC H04N 7/035
USPC 348/464

(57) ABSTRACT

A recorder for digital caption broadcast includes a video signal receiver, an audio signal receiver, and a caption data signal receiver that respectively receive video signals, audio signals, and caption data signals from a digital caption broadcast; a video signal transmitter, an audio signal transmitter, and a caption data signal transmitter that respectively receive signals from the video signal receiver, the audio signal receiver, and the caption data signal receiver and transmit the received signals to a viewer monitor; and a variable display adjustor provided between the video signal receiver and audio signal receiver, and the video signal transmitter and audio signal transmitter, the variable display adjustor being capable of adjusting timings of video display and sound generation to match caption display on the viewer monitor.

### BACKGROUND OF THE INVENTION

The present invention relates to a recorder for universal digital caption broadcast capable of receiving video signals, audio signals, and caption data signals from a digital caption broadcast that is in a foreign language, as well as Japanese. The recorder for universal digital caption broadcast variably adjusts the timings for video display and sound generation, and generates sound and displays video with caption data. In addition, the recorder for universal digital caption broadcast is capable of recording and storing only caption data on a universal serial bus (USB) flash drive or the like; enables setting of text size, text color, and display method (such as units of pages, number of displayed lines, and scrolling) on a monitor of a television or the like; and is capable of connecting to a printer, a Braille machine, and the like.

Conventionally, when caption data is generated from live video and audio, such as a real-time caption broadcast, the captions are displayed with a delay in relation to the video, causing viewers to feel uncomfortable with caption broadcasts.

To resolve shortcomings such as this, a caption broadcast system is being considered in which time lag between video and audio, and captions is reduced.

However, a caption broadcast system such as this requires changes in the conventional caption broadcast system. These changes are laborious and costly. Therefore, because large amounts of money cannot be spent on caption broadcasts that are unlikely to generate income, the reality is such systems are not put to practical use. Other methods are limited to those that match timings, at best. To ensure information accessibility for the deaf, an information accessibility system having both multifunctional and multilayered features is an absolute requisite. It should also be noted that this type of system will not be put to wide-spread practical use unless it has universal design features useful for not only the deaf but also the general public.

[Patent Literature 1] Japanese Patent Laid-open Publication No. 2010-81141

### SUMMARY OF THE INVENTION

The present invention has been achieved in light of the shortcomings of the past, such as that described above. An object of the present invention is to provide a recorder for digital caption broadcast capable of receiving video signals, audio signals, and caption data signals from a conventional caption broadcast, and displaying captions as is, without modulation, on a viewer monitor. The recorder for digital caption broadcast is additionally capable of modulated viewing display from level 0 to level 31 in units of seconds to match the timing of caption display, thereby enabling viewer-friendly operations and viewing in an optimal state.

Another object of the present invention is to provide a recorder for digital caption broadcast capable of recording and storing caption data, and reproducing and displaying the caption data on a viewer monitor as required, and enabling printout using a USB flash drive or the like.

The above-described objects of the present invention, as well as other objects and novel features of the present invention, will become more completely clear when the following description is read with reference to the accompanying drawings.

However, the drawings are provided mainly for descriptions and do not limit the technical scope of the present invention.

To achieve the above-described objects, the present

invention is a recorder for digital caption broadcast composed of: a video signal receiver, an audio signal receiver, and a caption data signal receiver that respectively receive video signals, audio signals, and caption data signals from a digital caption broadcast; a video signal transmitter, an audio signal transmitter, and a caption data signal transmitter that respectively receive signals from the video signal receiver, the audio signal receiver, and the caption data signal receiver and transmit the received signals to a viewer monitor; and a variable display adjustor provided between the video signal receiver and audio signal receiver, and the video signal transmitter and audio signal transmitter, the variable display adjustor being capable of adjusting timings of video display and sound generation to match caption display on the viewer monitor.

In addition, the recorder for digital caption broadcast is configured such that the caption data signal receiver is provided with a reproduction display device that records and stores caption data, and reproduces and displays the caption data on the viewer monitor.

Furthermore, the present invention is a recorder for digital caption broadcast composed of: a video signal receiver, an audio signal receiver, and a caption data signal receiver that respectively receive video signals, audio signals, and caption data signals from a broadcast, via a live-caption/recorded-caption identifying device that identifies whether a broadcast from a digital caption broadcast is a live caption broadcast or a recorded caption broadcast; a video signal transmitter, an audio signal transmitter, and a caption data signal transmitter that respectively receive signals from the video signal receiver, the audio signal receiver, and the caption data signal receiver and transmit the received signals to a viewer monitor; and a variable display adjustor provided between the video signal receiver and audio signal receiver, and the video signal transmitter and audio signal transmitter in which, when the live-caption/recorded-caption identifying device identifies the broadcast to be a live caption broadcast, the variable display adjustor enters an ON state in which timings of video display and sound generation can be adjusted to match the caption display on the viewer monitor and, when the live-caption/recorded-caption identifying device identifies the broadcast to be a recorded caption broadcast, the variable display adjustor enters an OFF state in which the signals received by the video signal receiver and the audio signal receiver are transmitted to the viewer monitor via the video signal transmitter and the audio signal transmitter without the timings being adjusted.

As is clear from the descriptions above, the present invention achieves the following effects.

(1) According to a first set of features of the invention, video signals, audio signals, and caption data signals from a conventional digital caption broadcast can be received, and captions can be displayed as is, without modulation, on a viewer monitor. In addition, video display and sound generation that have been variably adjusted to match the timing of the caption display can be performed.

Therefore, viewers can view even conventional digital caption broadcasts in an optimal state.

(2) Also as a result of (1), described above, equipment on the broadcasting station-side is not required to be changed. Therefore, caption broadcasts can be performed as in the past.

(3) As a result of (1), the recorder for digital caption broadcast can be used such as to be connected in a manner similar to a conventional recording and reproducing device that connects to caption broadcasts and a viewer monitor. Therefore, the recorder for digital caption broadcast can be easily used.

(4) As a further result of (1), text data is recorded

using the caption data signals. Therefore, an enormous archive of television programs can be easily and accurately searched by text search. In addition, during caption broadcasts such as broadcasts of Diet sessions, for example, shorthand recordings can be easily created in real-time by the text data being recorded, in other words, using a “text recording feature”. Therefore, promptness, publication, cost reduction, and the like of session minutes can be improved at once, thereby enhancing sessions.

(5) According to a second set of features of the invention as well, effects similar to those in (1) to (4), described above, can be achieved.

(6) According to a third set of features of the invention as well, effects similar to those described above in (1) to (4) can be achieved. In addition, caption data can be reproduced on a viewer monitor as required.

(7) According to a fourth set of features of the invention as well, effects similar to those described above in (1) to (4) can be achieved. In addition, caption display, video display, and sound generation can be optimally performed in a viewer's monitor even for live caption broadcasts and recorded caption broadcasts.

(8) According to a fifth set of features of the invention as well, effects similar to those described above in (1) to (4) and (7) can be achieved.

### BRIEF DESCRIPTION OF THE DRAWINGS

FIG. 1 is an explanatory diagram of a usage state according to a first embodiment of the present invention;

FIG. 2 is a block diagram according to the first embodiment of the present invention;

FIG. 3 is a front view according to the first embodiment of the present invention;

FIG. 4 is an explanatory diagram of a usage state according to a second embodiment of the present invention;

FIG. 5 is a block diagram according to the second embodiment of the present invention;

FIG. 6 is a front view according to the second embodiment of the present invention;

FIG. 7 is an explanatory diagram of a usage state according to a third embodiment of the present invention;

FIG. 8 is a block diagram according to the third embodiment of the present invention; and

FIG. 9 is a front view according to the third embodiment of the present invention.

### DETAILED DESCRIPTION OF THE INVENTION

The present invention will hereinafter be described in detail according to the embodiments of the present invention shown in the drawings.

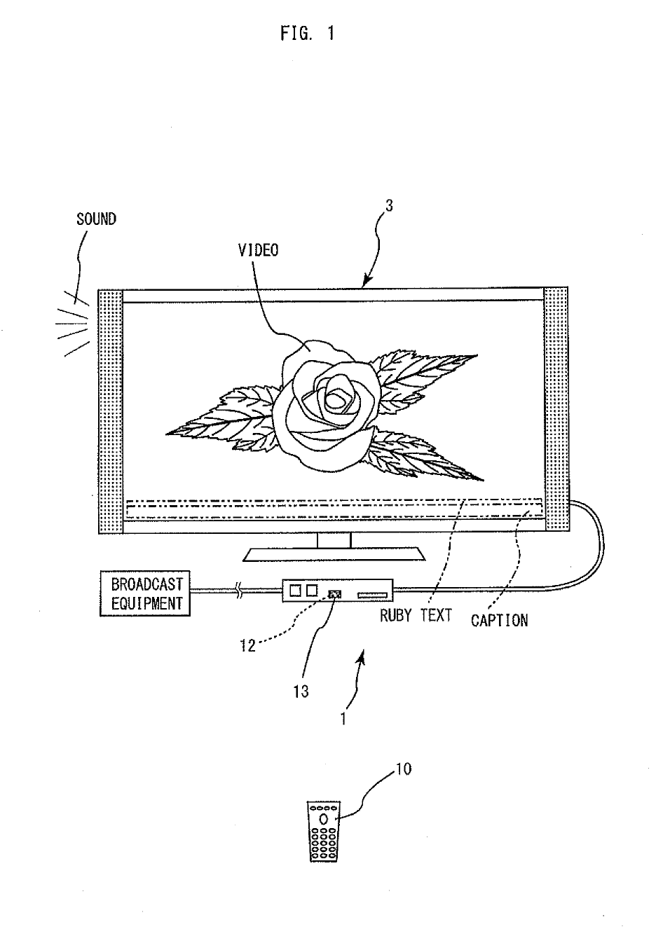

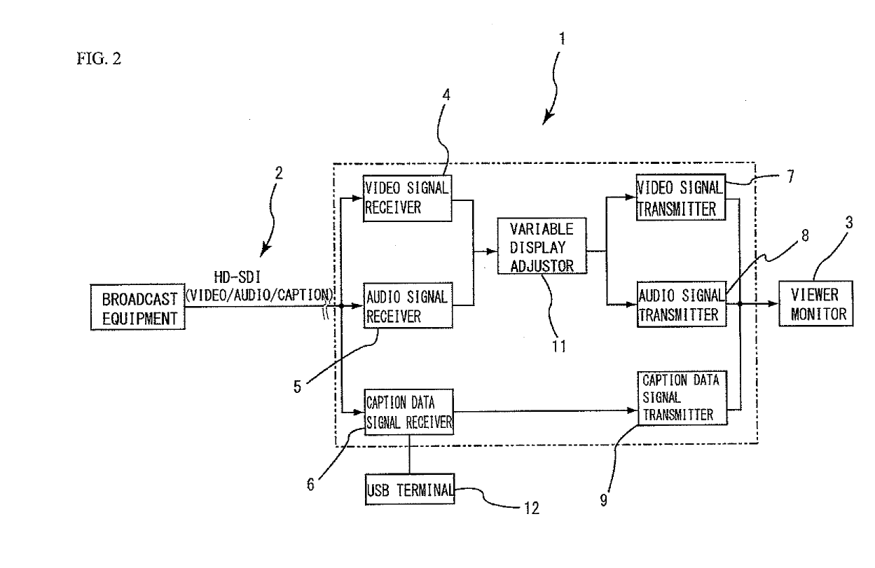

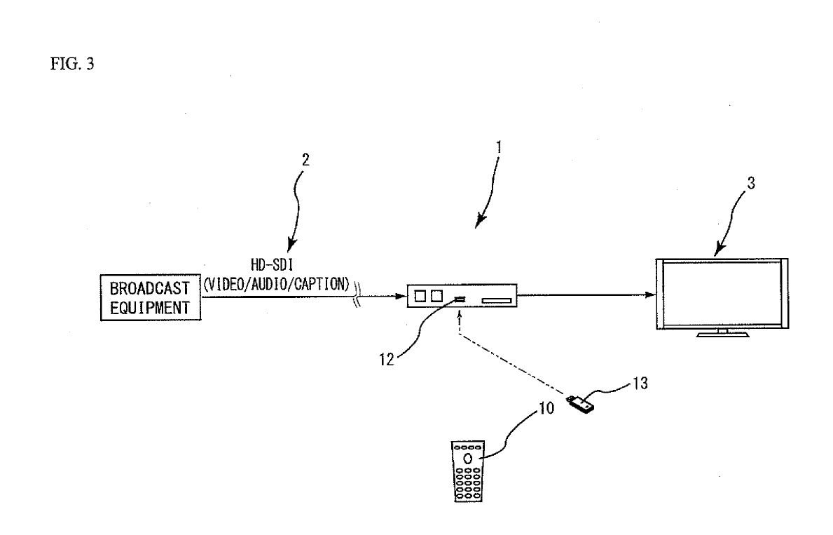

According to a first embodiment of the present invention shown in FIG. 1 to FIG. 3, reference number 1 represents a recorder for digital caption broadcast of the present invention. The recorder 1 for digital caption broadcast is capable of receiving video signals, audio signals, and caption data signals of a digital caption broadcast 2 and displaying captions as is, without modulation, on a viewer monitor 3. The recorder 1 for digital caption broadcast is also capable of performing video display and sound generation that have been variably adjusted to match the timing of the caption display. The recorder 1 for digital caption broadcast is composed of: a video signal receiver 4, an audio signal receiver 5, and a caption data signal receiver 6 that respectively receive video signals, audio signals, and caption data signals of the digital caption broadcast 2 by radio waves or over a cable; a video signal transmitter 7, an audio signal transmitter 8, and a caption data signal transmitter 9 that respectively receive signals from the video signal receiver 4, the audio signal receiver 5, and the caption data signal receiver 6 and transmit the received signals to the viewer monitor 3; and a variable display adjustor 11 provided between the video signal receiver 4 and audio signal receiver 5, and the video signal transmitter 7 and audio signal transmitter 8. The variable display adjustor 11 is capable of variably adjusting the timings for video display and sound generation to match the caption display that is displayed as is, without modulation, on the viewer monitor 3. The timings can be adjusted between 31 levels (0 to 31 seconds) by, for example, a remote controller 10.

The caption data signal receiver 6 is configured to record and store caption data such as to include date and time by a USB flash drive 13 being inserted into an USB terminal 12. The caption data recorded and stored such as to include date and time is in caption text file format and can be displayed on a television screen that is a viewer monitor.

Text size for reproduction display reproduced on the television screen can be variably set to large, medium, or small. Text color can be variably set to white, yellow, light blue, or green. Screen color can be variably set to black or blue. Display switching can be variably set to units of pages, one to eight lines, scrolling, or the like.

According to the first embodiment, the full text of the caption broadcast of a designated program is automatically recorded if the channel is set, even for programs not directly viewable on the television. In addition, the automatically recorded text data enables the broadcast content to be acquired in a personalized manner, such as “speed-reading”, “re-reading”, or “skimming”, regardless of the broadcast time.

In addition, the viewer monitor 3 can be a household television. A “television reader function” can be added to change the household television from a “viewing-only television” to an “advanced multifunctional television”.

Furthermore, when the USB flash drive 13 is inserted into a personal computer, text output can be performed by a printer. In addition, when the USB flash drive 13 is directly connected to a printer including a USB port, the text can be printed out instantly, even when a personal computer is not available.

In addition, viewers wish to have, in printed form, many of the various programs that are caption-broadcast. The recorder 1 for digital caption broadcast enables viewers to instantly print out the programs for personal use.

Text data on the USB flash drive 13 generated by a personal computer or the like can be directly displayed as text on the television screen when the USB flash drive 13 is inserted into the USB terminal 12.

Moreover, diversely expanded use of the recorder 1 for digital caption broadcast can be considered, such as connection to a peripheral Braille machine, devices for social care purposes, and the like, by taking advantage of the USB terminal 12.

### Other Embodiments of the Invention

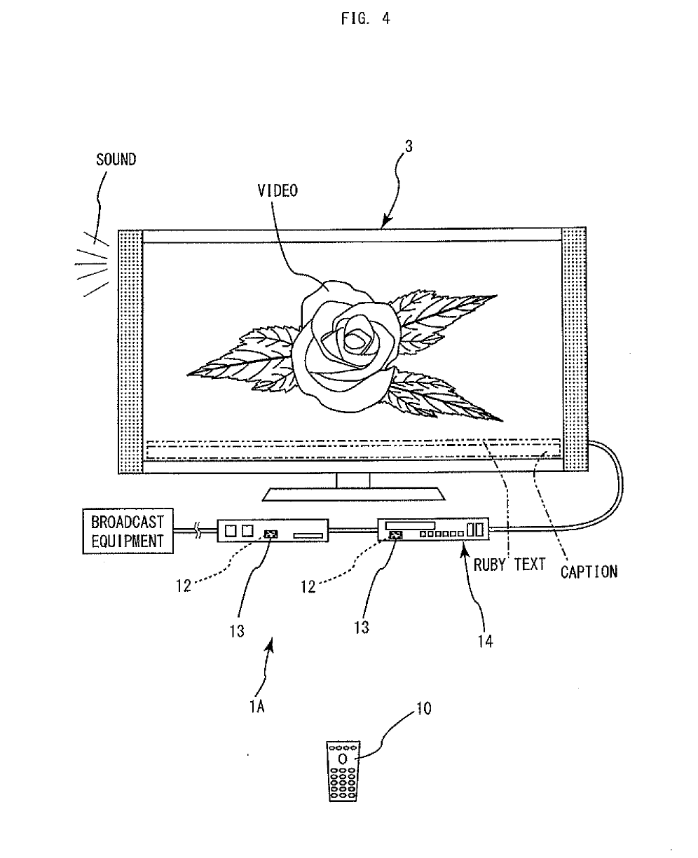

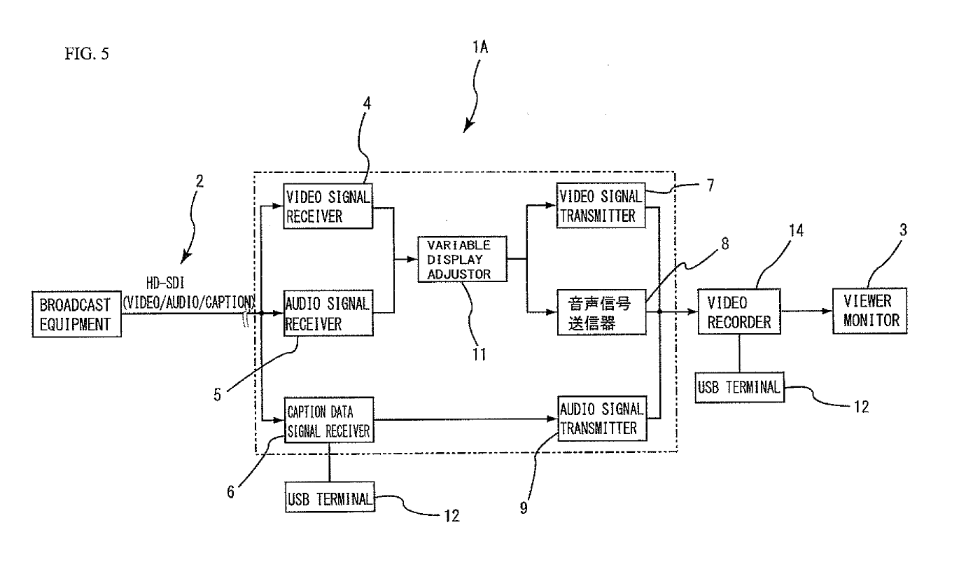

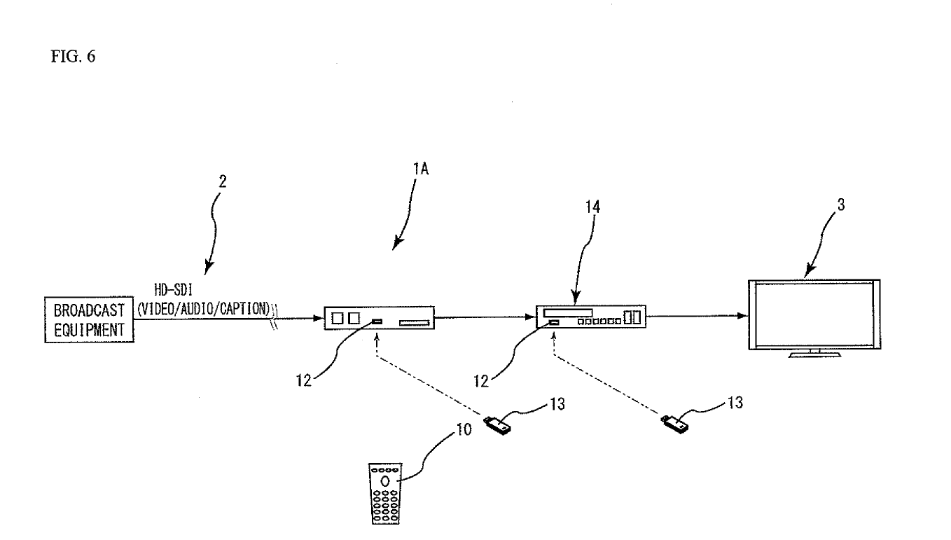

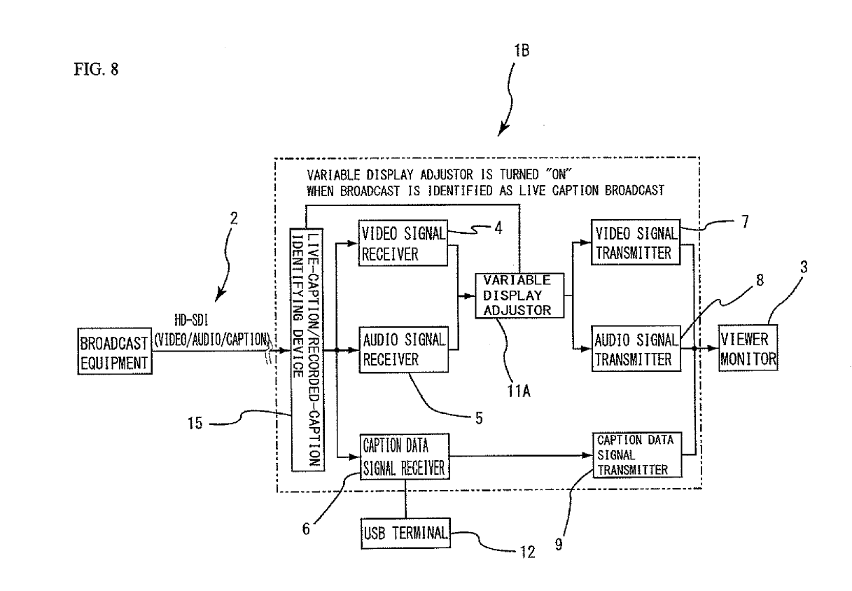

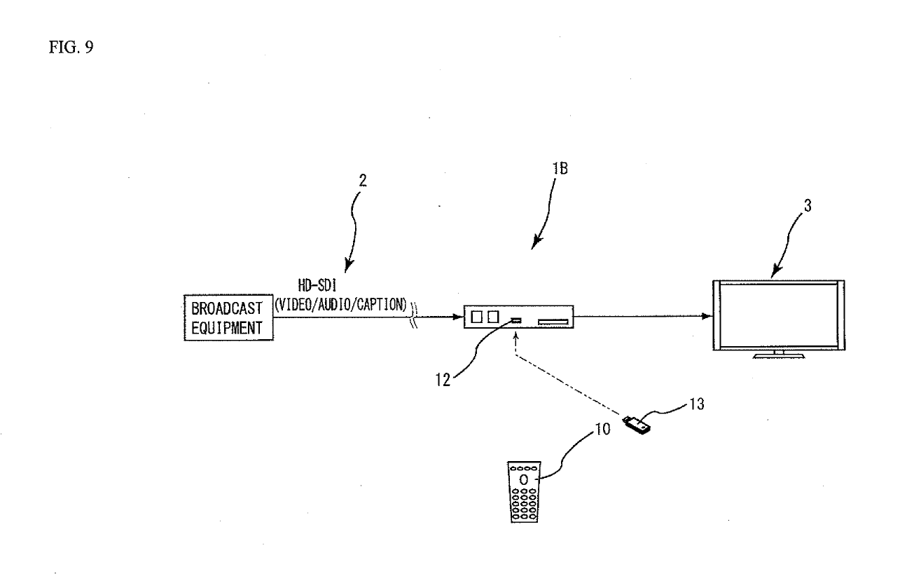

Next, other embodiments of the present invention shown in FIG. 4 to FIG. 9 will be described. In the description of the other embodiments of the present invention, constituent sections that are the same as those according to the first embodiment are given the same reference numbers. Repetitive descriptions are omitted.

According to a second embodiment of the present invention shown in FIG. 4 to FIG. 6, the invention mainly differs from that according to the first embodiment in that sound generation, video display, and caption display in the viewer monitor 3 can be performed through a video recorder 14. The video recorder 14 receives signals from the video signal transmitter 7, the audio signal transmitter B, and the caption data signal transmitter 9, and records and stores the signals therein such

as to include date and time. A recorder 1A for digital caption broadcast such as this can also achieve operational effects similar to those according to the first embodiment of the present invention. In addition, the recorder 1A for digital caption broadcast can reproduce digital caption broadcasts, as well as only captions, using the video recorder 14. Furthermore, the recorder 1A for digital caption broadcast can retrieve video by retrieving caption data from the data recorded and stored such as to include date and time using the video recorder 14.

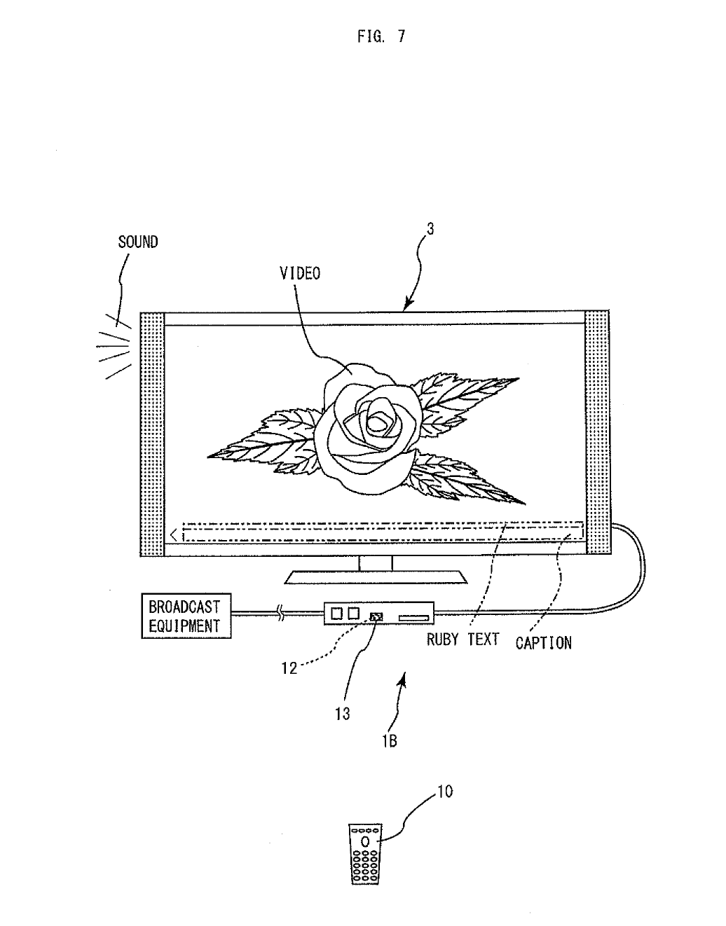

According to a third embodiment of the present invention shown in FIG. 7 to FIG. 9, the invention mainly differs from that according to the first embodiment in that a live-caption/recorded-caption identifying device 15 and a variable display adjustor 11A are provided. The live-caption/recorded-caption identifying device 15 identifies whether a broadcast from the digital caption broadcast 2 is a live caption broadcast or a recorded caption broadcast. When the live-caption/recorded-caption identifying device 15 identifies the broadcast to be a live caption broadcast, the variable display adjustor 11A enters an ON state in which the timings of video display and sound generation can be adjusted to match the caption display on the viewer monitor 3. When the live-caption/recorded-caption identifying device 15 identifies the broadcast to be a recorded caption broadcast, the variable display adjustor 11A enters an OFF state in which the signals received by the video signal receiver 4 and the audio signal receiver 5 are transmitted to the viewer monitor 3 via the video signal transmitter 7 and the audio signal transmitter 8 without the timings being adjusted. A recorder 1B for digital caption broadcast such as this can also achieve operational effects similar to those according to the first embodiment of the present invention. In addition, when the broadcast from the digital caption broadcast 2 is a live caption broadcast, video display and sound generation of which the timings have been automatically adjusted by the variable display adjustor 11A to match the caption display are performed in the viewer monitor 3. When the broadcast is a recorded caption broadcast, sound is generated and the video display is displayed on the viewer monitor 3 as is, without the timings being adjusted by the variable display adjustor 11A.

The live-caption/recorded-caption identifying device 15 can be that which performs identification only on the recorder 1B for digital caption broadcast-side that identifies the broadcast based on a display symbol >> displayed in front of the caption in the digital caption broadcast 2. Alternatively, the live-caption/recorded-caption identifying device 15 can be that which performs identification based on an identifier signal provided by the broadcast equipment-side. The identifier signal indicates live caption broadcast when the broadcast is a live caption broadcast.

The present invention can be used in the industry of manufacturing a recorder for digital caption broadcast capable of receiving video signals, audio signals, and caption data signals from a digital caption broadcast that is in a foreign language, as well as Japanese, and displaying captions as is, without modulation, on a viewer monitor. In addition, the recorder for digital caption broadcast is capable of performing video display and sound generation that have been variably adjusted to match the timing of the caption display.

What is claimed is:

1. A recorder for digital caption broadcast comprising:
a video signal receiver, an audio signal receiver, and a caption data signal receiver that respectively receive video signals, audio signals, and caption data signals from a digital caption broadcast;
a video signal transmitter, an audio signal transmitter, and a caption data signal transmitter that respectively receive signals from the video signal receiver, the audio signal receiver, and the caption data signal receiver and transmit the received signals to a viewer monitor; and
a variable display adjustor provided between the video signal receiver and audio signal receiver, and the video signal transmitter and audio signal transmitter, the variable display adjustor being capable of adjusting timings of video display and sound generation to match caption display on the viewer monitor.

2. The recorder for digital caption broadcast according to claim 1, wherein the variable display adjustor is capable of matching sound generation and video display in the viewer monitor with the display timing of the caption display.

3. The recorder for digital caption broadcast according to claim 1, wherein the caption data signal receiver is provided with a reproduction display device that records and stores caption data, and reproduces and displays the caption data on the viewer monitor.

4. A recorder for digital caption broadcast comprising:
a video signal receiver, an audio signal receiver, and a caption data signal receiver that respectively receive video signals, audio signals, and caption data signals from a broadcast, via a live-caption/recorded-caption identifying device that identifies whether a broadcast from a digital caption broadcast is a live caption broadcast or a recorded caption broadcast;
a video signal transmitter, an audio signal transmitter, and a caption data signal transmitter that respectively receive signals from the video signal receiver, the audio signal receiver, and the caption data signal receiver and transmit the received signals to a viewer monitor; and
a variable display adjustor provided between the video signal receiver and audio signal receiver, and the video signal transmitter and audio signal transmitter in which, when the live-caption/recorded-caption identifying device identifies the broadcast to be a live caption broadcast, the variable display adjustor enters an ON state in which timings of video display and sound generation can be adjusted to match the caption display on the viewer monitor and, when the live-caption/recorded-caption identifying device identifies the broadcast to be a recorded caption broadcast, the variable display adjustor enters an OFF state in which the signals received by the video signal receiver and the audio signal receiver are transmitted to the viewer monitor via the video signal transmitter and the audio signal transmitter without the timings being adjusted.

5. The recorder for digital caption broadcast according to claim 4, wherein the live-caption/recorded-caption identifying device performs identification based on a symbol in front of a caption of the digital caption broadcast or an identifier signal indicating a live caption broadcast provided by a broadcast equipment-side.
